(19) United States
(12) Patent Application Publication
(10) Pub. No.: US 2009/0225266 A1
(43) Pub. Date: Sep. 10, 2009

(54) MULTI-DOMAIN VERTICAL ALIGNMENT THIN FILM TRANSISTOR LIQUID CRYSTAL DISPLAY

(75) Inventor: Po-Lun Chen, Chiayii (TW)

Correspondence Address: J C PATENTS, INC., 4 VENTURE, SUITE 250, IRVINE, CA, 92618, US

(73) Assignee: AU OPTRONICS CORPORATION, Hsinchu (TW)

(21) Appl. No.: 12/469,124

(22) Filed: May 20, 2009

Related U.S. Application Data
(62) Division of application No. 11/548,973, filed on Oct. 12, 2006.
Application No. 11/548,973 is a division of application No. 10/708,297, filed on Feb. 23, 2004, now abandoned.

(30) Foreign Application Priority Data
Oct. 29, 2003 (TW) 92120001

(51) Int. Cl. G02F 1/1337

(52) U.S. Cl. 349/130; 349/129

(57) ABSTRACT

A multi-domain vertical alignment thin film transistor liquid crystal display (MVA TFT-LCD) device is disclosed. The MVA TFT-LCD comprises a MVA TFT-LCD panel, a first wide viewing film (WV film), a first polarizer film, a second WV film, and a second polarizer film. The first WV film is on the first surface of the MVA TFT-LCD panel. The first polarizer film is on the first WV film, wherein diffusive patterns are formed on surface of the first polarizer. The second WV film is on the second surface of the MAV TFT-LCD panel. The second polarizer film is on the second WV film. The MVA TFT-LCD of the invention can reduce the issues of color shift and color washing out resulting from the change of the view angle.

### CROSS-REFERENCE TO RELATED APPLICATION

This application is a divisional of and claims the priority benefit of an application Ser. No. 11/548,973, filed on Oct. 12, 2006, which is a divisional of an application Ser. No. 10/708,297, filed on Feb. 23, 2004. The application Ser. No. 10/708,297 claims the priority benefit of Taiwan application serial no. 92120001, filed on Oct. 29, 2003. The entirety of each of the above-mentioned patent applications is hereby incorporated by reference herein and made a part of this specification.

### BACKGROUND OF THE INVENTION

1. Field of the Invention

The present invention relates to a multi-domain vertical alignment thin film transistor liquid crystal display, and more particularly to a multi-domain vertical alignment thin film transistor liquid crystal display adapted to resolve issues of color shift and color washing out resulting from change of view angle.

2. Description of the Related Art

Because of the shrinkage of semiconductor device and displays, portable devices are more available to people. As to displays, cathode ray tubes (CRT) have dominated the market as their high quality and economy. However, because of space restriction, power consumption and concern of environmental protection, CRT still have some issues needed to be resolved. Therefore, because of its high quality, space utility, low power consumption and non-radiation, thin film transistor liquid crystal display (TFT LCD) has gradually replaced CRT.

To date, the liquid crystal displays with high contrast ratio, no gray scale inversion, little color shift, high luminance, full color, high brightness, high responsive speed and wide view angle are required. In order to achieve the purpose of wide view angle, some displays, such as TN complying with wide viewing film display, in-plane switching display (IPS), fringe field switching display and multi-domain vertical alignment display (MAV), are developed to perform the purpose. Following are the descriptions of the prior art multi-domain vertical alignment thin film transistor liquid crystal display.

FIG. 1 is a schematic cross-sectional view showing a prior art multi-domain vertical alignment thin film transistor liquid crystal display. Referring to FIG. 1, the multi-domain vertical alignment thin film transistor liquid crystal display comprises a multi-domain vertical alignment thin film transistor liquid crystal display panel 116, a first wide viewing film 108, a first polarizer film 110, a second wide viewing film 112 and a second polarizer film 114. The first wide viewing film 108 is on a first surface 116a of the thin film transistor liquid crystal display panel 116. The first polarizer film 110 is on the first viewing film 108. The second wide viewing film 112 is on a second surface 116b of the thin film transistor liquid crystal display panel 116. The second polarizer film 114 is on the second wide viewing film 112. The multi-domain vertical alignment thin film transistor liquid crystal display panel 116 comprises a color filter substrate 102, a thin film transistor array substrate 100, a liquid crystal layer 104 and protrusions 106, wherein the protrusions 106 are used to arrange the directions of the liquid crystal molecules. Moreover, the protrusions 106 can be disposed on the color filter substrate 102 or the thin film transistor array substrate 100, or on both of them.

As to the prior art multi-domain vertical alignment thin film transistor liquid crystal display, the transmittance-level curve varies with the change of view angle. In other word, the change of view angle will result in color shift and color washing out. If these issues can be resolved, the multi-domain vertical alignment thin film transistor liquid crystal display will be more competitive.

### SUMMARY OF THE INVENTION

Therefore, the object of the present invention is to provide a multi-domain vertical alignment thin film transistor liquid crystal display (MVA TFT-LCD) for resolving the issues of color shift and color washing out resulting from the change of the viewing angle.

The present invention discloses a multi-domain vertical alignment thin film transistor liquid crystal display, which comprises a multi-domain vertical alignment thin film transistor liquid crystal display panel, a first wide viewing film, a first polarizer film, a second wide viewing film and a second polarizer film. The first wide viewing film is on a first surface of the thin film transistor liquid crystal display panel. The first polarizer film is on the first viewing film, wherein a surface of the first polarize film has a diffusive pattern. Additionally, the second wide viewing film is on a second surface of the thin film transistor liquid crystal display panel. The second polarizer film is on the second wide viewing film.

The present invention discloses another multi-domain vertical alignment thin film transistor liquid crystal display, which comprises a thin film transistor array substrate, a color filter substrate, a liquid crystal layer, a first wide viewing film, a first polarizer, a second wide viewing film and a second polarizer. The color filter substrate is over the thin film transistor array substrate, wherein the color filter substrate has diffusive particles. Additionally, the liquid crystal layer is between the thin film transistor array substrate and the color filter substrate. The first wide viewing film is on a surface of the color filter substrate. The first polarizer is on the first wide viewing film. The second wide viewing film is on a surface of the thin film transistor array substrate. The second polarizer is on the second wide viewing film.

The present invention discloses a method of fabricating a polarizer film applied to a multi-domain vertical alignment thin film transistor liquid crystal display. First, the method provides a substrate and forms an optical thin film thereon. Then, a diffusive pattern is formed on a surface of the optical thin film for forming a polarizer film having a diffusive pattern. The method of forming the diffusive pattern on the surface of the optical thin film comprises, for example, photolithographic and etching technologies for forming the diffusive pattern on the surface of the optical thin film, or the formation of a diffusive film on the surface of the optical thin film.

The present invention discloses a method of fabricating a color filter substrate applied to a multi-domain vertical alignment thin film transistor liquid crystal display. First, the method provides a substrate and forms a black matrix and a color photoresist layer thereon, wherein the color photoresist layer has diffusive particles. The method of forming the color photoresist layer having the diffusive particles comprises, for example, spreading the diffusive particles within the color photoresist layer or forming a diffusive film thereon.

Because the multi-domain vertical alignment thin film transistor liquid crystal display of the present invention uses the polarizer film having the diffusive pattern or particles or the color filter substrate having the diffusive particles, light from the display has a specific diffusive angle for modifying the transmittance-level curve corresponding to different view angles. Therefore, the distribution of transmittance-level curve corresponding to different view angles is corrected and the issues of color shift and color washing out resulting from the change of the viewing angle are reduced.

In order to make the aforementioned and other objects, features and advantages of the present invention understandable, a preferred embodiment accompanied with figures is described in detail below.

### BRIEF DESCRIPTION OF THE DRAWINGS

FIG. 1 is a schematic cross-sectional view showing a prior art multi-domain vertical alignment thin film transistor liquid crystal display.

FIG. 2 is a schematic cross-sectional view showing a preferred multi-domain vertical alignment thin film transistor liquid crystal display of the present invention.

FIG. 3A is a schematic cross-sectional view showing a preferred polarizer film applied to a multi-domain vertical alignment thin film transistor liquid crystal display of the present invention.

FIG. 3B is a schematic cross-sectional view showing another preferred polarizer film applied to a multi-domain vertical alignment thin film transistor liquid crystal display of the present invention.

FIG. 4 is a schematic cross-sectional view showing another preferred multi-domain vertical alignment thin film transistor liquid crystal display of the present invention.

FIG. 5A is a schematic cross-sectional view showing a preferred color filter substrate applied to a multi-domain vertical alignment thin film transistor liquid crystal display of the present invention.

FIG. 5B is a schematic cross-sectional view showing another preferred color filter substrate applied to a multi-domain vertical alignment thin film transistor liquid crystal display of the present invention.

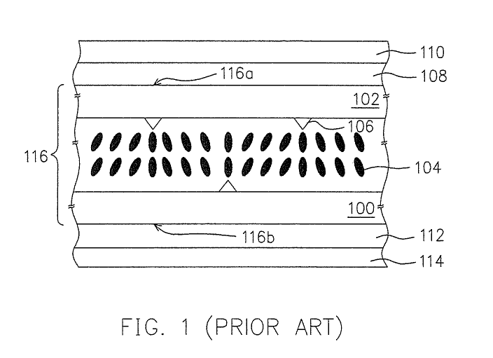

### DESCRIPTION OF SOME EMBODIMENTS

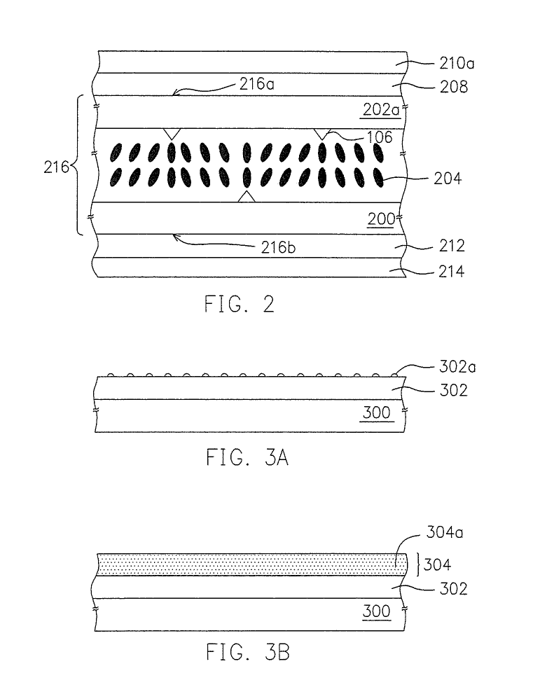

FIG. 2 is a schematic cross-sectional view showing a preferred multi-domain vertical alignment thin film transistor liquid crystal display of the present invention. Referring to FIG. 2, the multi-domain vertical alignment thin film transistor liquid crystal display comprises a multi-domain vertical alignment thin film transistor liquid crystal display panel 216, a first wide viewing film 208, a first polarizer film 210a, a second wide viewing film 212 and a second polarizer film 210b. The multi-domain vertical alignment thin film transistor liquid crystal display panel 216 comprises a color filter substrate 202a, a thin film transistor array substrate 200, a liquid crystal layer 204 and protrusions 206, wherein the protrusions 206 are used to arrange the directions of the liquid crystal molecules.

The first wide viewing film 208 is on a first surface 216a of the thin film transistor liquid crystal display panel 216. The first polarizer film 210a is on the first viewing film 208. The second wide viewing film 212 is on a second surface 216b of the thin film transistor liquid crystal display panel 216. The second polarizer film 214 is on the second wide viewing film 212. Generally, the polarizer film includes an iodine type polarizer and dye type polarizer, wherein the polarizer film applied to active array LCD is an iodine type polarizer.

In the embodiment, the method of reducing color shift resulting from the change of view angles comprises forming a diffusive pattern on the surface of the first polarizer film 210a for forming a polarizer film having a diffusive structure. In another embodiment, a diffusive film is formed on the first polarizer film 210a. Both of them can make the first polarizer film have diffusive characteristic. Following are the detail descriptions for these two methods.

FIG. 3A is a schematic cross-sectional view showing a preferred polarizer film applied to a multi-domain vertical alignment thin film transistor liquid crystal display of the present invention. Referring to FIG. 3A, a substrate 300 is provided and an optical thin film 302 is formed thereon. Then, a diffusive pattern 302a is formed on the optical thin film 302. The method of forming the diffusive pattern 302a on the surface of the optical thin film 302 comprises, for example, photolithographic and etching technologies for patterning the surface of the optical thin film 302. The polarizer film 210a formed therefrom is composed of the substrate 300, the optical thin film 302 and the diffusive pattern 302a, wherein the optical thin film 302 is on the substrate 300. The diffusive pattern is on the optical thin film 302. The other surface of the substrate 300 is attached to the first wide viewing film 208.

FIG. 3B is a schematic cross-sectional view showing another preferred polarizer film applied to a multi-domain vertical alignment thin film transistor liquid crystal display of the present invention. Referring to FIG. 3B, a substrate 300 is provided and an optical thin film 302 is formed thereon. Then, a diffusive film 304 is formed on the optical thin film 302, wherein the diffusive film 304 is composed of, for example, a transparent film and diffusive particles 304a spared therein. The polarizer film formed therefrom is composed of the substrate 300, the optical thin film 302 and the diffusive film 304, wherein the optical thin film 302 is on the substrate 300. Additionally, the diffusive film 304 is on the optical thin film 302 and has diffusive particles 304a therein.

In addition to resolving the issues of color shift and color washing out resulting from the change of the viewing angle by the polarizer film and the diffusive pattern, the present invention can also uses a color filter substrate having the diffusive pattern to resolve the issues mentioned above. Following is the detail description.

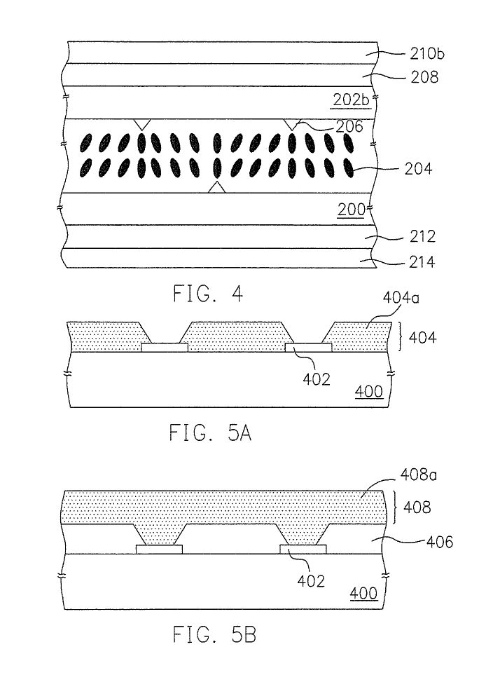

FIG. 4 is a schematic cross-sectional view showing another preferred multi-domain vertical alignment thin film transistor liquid crystal display of the present invention. Referring to FIG. 4, the liquid crystal display comprises a thin film transistor array substrate 200, a color filter substrate 202b, a liquid crystal layer 204, a first wide viewing film 208, a first polarizer 210b, a second wide viewing film 212 and a second polarizer 214. The color filter substrate 202b is over the thin film transistor array substrate 200, wherein the color filter substrate 202b has diffusive particles. Additionally, the liquid crystal layer 204 is between the thin film transistor array substrate 200 and the color filter substrate 202b. The first wide viewing film 208 is on a surface of the color filter substrate 202b. The first polarizer 210b is on the first wide viewing film 208. The second wide viewing film 212 is on a surface of the thin film transistor array substrate 200. The second polarizer 214 is on the second wide viewing film 212.

It should be noted that the method of fabricating the color filter substrate 202b having the diffusive particles can comprise, for example, spreading the diffusive particles (not shown) in a color photoresist layer (not shown) of the color filter substrate 202b, or forming a diffusive film (not shown) on a color photoresist layer (not shown) of the color filter substrate 202b. Following are the detail descriptions of these two methods.

FIG. 5A is a schematic cross-sectional view showing a preferred color filter substrate applied to a multi-domain vertical alignment thin film transistor liquid crystal display of the present invention. Referring to FIG. 5A, a substrate 400 is provided and a black matrix 402 is formed thereon. If the material of the black matrix 402 is opaque resin, it can be formed by photolithographic processes; if the material of the black matrix 402 is Cr, it can be formed by photolithographic and etching processes. In addition, the substrate 400 can be glass, plastic or transparent material. A color photoresist layer 404 is then formed on the substrate 400 covering a portion of the black matrix 402, wherein the color photoresist layer 404 is composed of pluralities of red-color photoresist blocks (not shown), green-color photoresist blocks (not shown) and blue-color photoresist blocks (not shown). The color photoresist layer 404 has diffusive particles 404a therein. The method of forming the color photoresist layer 404 on the substrate 400 can comprise, for example, performing a spin-coating process and a baking process for forming a red-color photoresist layer (not shown), wherein the red-color photoresist layer has diffusive particles spared therein. Then a lithographic process is performed for reserving a specific area of red-color photoresist layer (not shown). The processes described above are repeated for forming specific areas of green-color photoresist layer and blue-color photoresist layer (not shown). The color filter substrate formed thereform comprises the substrate 400, the black matrix 402 and the color photoresist layer 404, wherein the black matrix 402 is on the substrate 400. Additionally, the color photoresist layer 404 is on the substrate 400 covering a portion of the black matrix 402, wherein the color photoresist layer 404 has diffusive particles 404a spared therein.

FIG. 5B is a schematic cross-sectional view showing another preferred color filter substrate applied to a multi-domain vertical alignment thin film transistor liquid crystal display of the present invention. Referring to FIG. 5B, a substrate 400 is provided and a black matrix 402 is formed thereon. A color photoresist layer 406 is then formed on the substrate 400 covering a portion of the black matrix 402. Finally, a diffusive film 408 is formed on the color photoresist layer 406, wherein the diffusive film 408 is composed of, for example, a transparent film and diffusive particles 408a spared therein. The color filter substrate formed thereform comprises the substrate 400, the black matrix 402, the color photoresist layer 406 and the diffusive film 408. The black matrix 402 is on the substrate 400. The color photoresist layer 406 is on the substrate 400 covering a portion of the black matrix 402. Additionally, the diffusive film 408 is on the color photoresist layer 406 and the black matrix 402. The color filter substrate described above can further comprise an electrode film, a planarization film, an optical film, etc.

Because the multi-domain vertical alignment thin film transistor liquid crystal display of the present invention uses the polarizer film having the diffusive pattern or particles or the color filter substrate having the diffusive particles, light from the display has a specific diffusive angle for modifying the transmittance-level curve corresponding to different view angles. Therefore, the distribution of transmittance-level curve corresponding to different view angles is corrected and the issues of color shift and color washing out resulting from the change of the viewing angle are reduced. Accordingly, the multi-domain vertical alignment thin film transistor liquid crystal display of the present invention has following advantages:

1. The present invention can reduce the issues of color shift and color washing out resulting from the change of the viewing angle without changing pixel structures; and

2. The present invention can reduce the issues of color shift and color washing out resulting from the change of the viewing angle without changing the relationship between the transparency and gray level.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A multi-domain vertical alignment thin film transistor liquid crystal display (MVA TFT-LCD), comprising:
a multi-domain vertical alignment thin film transistor liquid crystal display panel;
a first wide viewing film disposed on a first surface of the thin film transistor liquid crystal display panel;
a first polarizer film disposed on the first viewing film;
a diffusive film disposed on the surface of the first polarizer film;
a second wide viewing film disposed on a second surface of the thin film transistor liquid crystal display panel; and
a second polarizer film disposed on the second wide viewing film.

2. The multi-domain vertical alignment thin film transistor liquid crystal display of claim 1, wherein the diffusive film is disposed on an outer surface of the first polarizer film and the first polarizer film is between the diffusive film and the multi-domain vertical alignment thin film transistor liquid crystal display panel.
